(19) United States
(12) Patent Application Publication
(10) Pub. No.: US 2026/0152035 A1
(43) Pub. Date: Jun. 4, 2026

(54) THERMAL MANAGEMENT DEVICE FOR VEHICLE

(71) Applicant: TOYOTA JIDOSHA KABUSHIKI KAISHA, Toyota-shi (JP)

(72) Inventors: Kasumi KOBAYASHI, Toyota-shi (JP); Haruka TSURUTA, Toyota-shi (JP)

(73) Assignee: TOYOTA JIDOSHA KABUSHIKI KAISHA, Toyota-shi (JP)

(21) Appl. No.: 19/360,175

(22) Filed: Oct. 16, 2025

(30) Foreign Application Priority Data
Dec. 2, 2024 (JP) 2024-209340

(51) Int. Cl. B60H 1/00; B60H 1/22

(52) U.S. Cl. CPC B60H 1/00278; B60H 1/00492; B60H 1/2218; B60H 2001/2271

(57) ABSTRACT

A battery thermal circuit receives, in a heat exchanger, heat from a high-temperature side heat medium flowing through a channel of an HT thermal circuit, and the temperature of a battery is increased. An electric pump (first electric pump) and an internal combustion engine are disposed in the channel of the HT thermal circuit (first thermal circuit). An electric pump (second electric pump) and an electric heater are provided in the channel of the HT thermal circuit. When a request is made to increase the temperature of the battery and the temperature of the high-temperature side heat medium of the channel is a predetermined temperature or higher, the electric pump is operated, and the ports of a four-way valve are connected. When the temperature is lower than the predetermined temperature, the electric pump is operated, the electric heater is energized, and the ports of the four-way valve are connected.

### CROSS-REFERENCE TO RELATED APPLICATION

This application claims priority to Japanese Patent Application No. 2024-209340 filed on December 2, 2024. The disclosure of the above-identified application, including the specification, drawings, and claims, is incorporated by reference herein in its entirety.

### BACKGROUND

### 1. Technical Field

The present disclosure relates to a thermal management device for a vehicle.

### 2. Description of Related Art

Japanese Unexamined Patent Application Publication No. 2024-133774 (JP 2024-133774 A) discloses a battery temperature adjustment system for a hybrid electric vehicle including an engine and a vehicle drive motor. In this battery temperature adjustment system, when the hybrid electric vehicle is traveling in an HV mode and the vehicle cabin is being heated, an electric pump provided in an engine coolant circuit is operated in addition to an engine-driven pump to cause an engine coolant to flow through a water-water heat exchanger, thereby heating a battery. When the vehicle is not being heated, the engine-driven pump causes the engine coolant to flow through the water-water heat exchanger, thereby heating the battery.

### SUMMARY

In the battery temperature adjustment system of JP 2024-133774 A, it is difficult to heat the battery with the engine coolant while the engine-driven pump is stopped (while the engine is stopped). While the engine is stopped, a water heater (electric heater) is operated to heat the battery even if the temperature of the engine coolant is relatively high. For this reason, there is a concern that the power consumption of the electric heater is relatively large.

An object of the present disclosure is to increase the temperature of a battery while reducing the power consumption of an electric heater.

A thermal management device for a vehicle according to the present disclosure is a thermal management device for a vehicle including an internal combustion engine, a motor, and a battery that is a power source for the motor. The thermal management device includes: a battery thermal circuit through which a heat medium circulates to adjust a temperature of the battery; a first thermal circuit configured to cool the internal combustion engine using a heat medium circulated by a first electric pump; a second thermal circuit in which a temperature of a heat medium circulated by a second electric pump is increased by an electric heater; and a heat exchanger configured to exchange heat between each of the heat medium flowing through the first thermal circuit and the heat medium flowing through the second thermal circuit and the heat medium circulating through the battery thermal circuit. In the thermal management device, when a request is made to increase the temperature of the battery and a temperature of the heat medium of the first thermal circuit is equal to or higher than a predetermined temperature, the first electric pump is driven, and heat is exchanged between the heat medium of the first thermal circuit and the heat medium of the battery thermal circuit. In the thermal management device, when a request is made to increase the temperature of the battery and the temperature of the heat medium of the first thermal circuit is lower than the predetermined temperature, the second electric pump is driven, the electric heater is energized, and heat is exchanged between the heat medium of the second thermal circuit and the heat medium of the battery thermal circuit.

After the warm-up of the internal combustion engine is completed, the temperature of the heat medium (coolant temperature) that cools the internal combustion engine may be relatively high even while the internal combustion engine is stopped. In this configuration, when a request is made to increase the temperature of the battery and the temperature of the heat medium of the first thermal circuit that cools the internal combustion engine is equal to or higher than the predetermined temperature, the first electric pump is driven, and heat is exchanged between the heat medium of the first thermal circuit and the heat medium of the battery thermal circuit. When a request is made to increase the temperature of the battery and the temperature of the heat medium of the first thermal circuit that cools the internal combustion engine is lower than the predetermined temperature, the second electric pump is driven, the electric heater is energized, and heat is exchanged between the heat medium of the second thermal circuit and the heat medium of the battery thermal circuit. Therefore, even while the internal combustion engine is stopped, the temperature of the battery can be increased using the waste heat from the internal combustion engine. When the waste heat from the internal combustion engine cannot be used, the temperature of the battery can be increased by the electric heater. Thus, it is possible to increase the temperature of the battery while reducing the power consumption of the electric heater.

The electric heater may preferably be energized using electric power of the battery that is the power source for the motor. Since the power consumption of the electric heater is reduced, a decrease in the cruising distance of the vehicle due to an increase in temperature of the battery can be suppressed.

An air conditioner configured to perform heating in a vehicle cabin may preferably be provided, and the heat medium flowing through the first thermal circuit and the heat medium flowing through the second thermal circuit may preferably be used for the heating. With this configuration, the electric heater to be used for the heating can be used for increasing the temperature of the battery.

According to the present disclosure, it is possible to increase the temperature of the battery while reducing the power consumption of the electric heater.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a schematic configuration of a thermal management device for a vehicle according to an embodiment of the present disclosure;

FIG. 2 is a flowchart showing an example of a battery temperature increase control process to be performed by an ECU;

FIG. 3 illustrates an increase in temperature of a battery using waste heat from an internal combustion engine; and

FIG. 4 illustrates an increase in temperature of the battery using an electric heater.

### DETAILED DESCRIPTION OF EMBODIMENTS

An embodiment of the present disclosure will be described in detail with reference to the drawings. The same or corresponding parts are denoted by the same signs throughout the drawings, and description thereof will not be repeated.

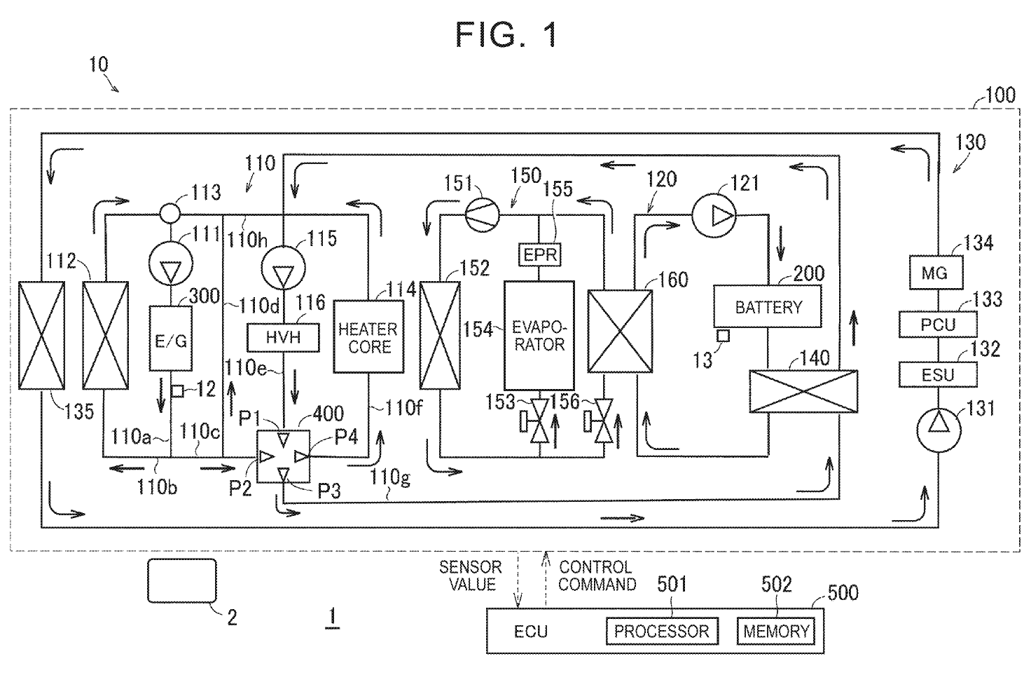

FIG. 1 shows a schematic configuration of a thermal management device 10 for a vehicle 1 according to the present embodiment. The vehicle 1 is a hybrid electric vehicle including a battery 200, an internal combustion engine 300, and a drive motor (motor generator: MG) 134. The vehicle 1 of the present embodiment is a plug-in hybrid electric vehicle in which the battery 200 can be charged externally, but may be an HEV in which the battery 200 is not charged externally.

The thermal management device 10 includes a thermal management circuit 100 and an electronic control unit (ECU) 500. The ECU 500 includes a processor 501 and a memory 502. The processor 501 executes programs stored in the memory 502 to perform various types of thermal management control in the ECU 500. The ECU 500 controls electric pumps 111, 115, 121, 131, a four-way valve 400, etc. described later.

The thermal management device 10 is configured to perform thermal management of the vehicle 1 using heat media of the thermal management circuit 100. The thermal management circuit 100 includes an HT thermal circuit 110, a battery thermal circuit 120, an LT thermal circuit 130, a refrigeration cycle 150, and the ECU 500.

The HT thermal circuit 110 includes a channel through which a high-temperature side heat medium flows and circulates. The HT thermal circuit 110 includes the electric pump 111, a high-temperature radiator 112, a thermostat 113, a heater core 114, the electric pump 115, and an electric heater 116. The HT thermal circuit 110 also includes the internal combustion engine 300 and the four-way valve 400. The high-temperature side heat medium may be a coolant such as a long life coolant (LLC). The high-temperature side heat medium exchanges heat with each device while passing through each device. The four-way valve 400 includes ports P1 to P4, and is an example of a "switching valve" according to the present disclosure.

The electric pump 111 and the internal combustion engine 300 are provided in a channel 110a connected to the thermostat 113. When the electric pump 111 is operated, the high-temperature side heat medium flows through the internal combustion engine 300. The channel 110a downstream of the internal combustion engine 300 branches into a channel 110b and a channel 110c. The high-temperature radiator 112 is provided in the channel 110b, and the downstream side of the high-temperature radiator 112 joins the thermostat 113. The channel 110c is connected to the port P2 of the four-way valve 400, and branches into a bypass channel 110d. The bypass channel 110d joins the thermostat 113 via a junction channel 110h.

The electric pump 115 and the electric heater 116 are provided in a channel 110e. When the electric pump 115 is operated, the high-temperature side heat medium flows through the electric heater 116. The channel 110e downstream of the electric heater 116 is connected to the port P1 of the four-way valve 400.

The port P4 of the four-way valve 400 is connected to a channel 110f. The heater core 114 is disposed in the channel 110f, and the channel 110f downstream of the heater core 114 is connected to the junction channel 110h. The heater core 114 is used as a heating source (heat source) of an air conditioner 2.

A channel 110g is connected to the port P3 of the four-way valve 400. The channel 110g is connected to a heat exchanger 140, and the channel 110g downstream of the heat exchanger 140 is connected to the junction channel 110h.

The battery thermal circuit 120 includes a channel through which a heat medium flows and circulates. The heat medium of the battery thermal circuit 120 may be insulating oil or insulating antifreeze. The electric pump 121, the battery 200, the heat exchanger 140, and a chiller 160 are disposed in the channel of the battery thermal circuit 120. The electric pump 121 circulates the heat medium through the battery thermal circuit 120. The heat medium exchanges heat with each device while passing through each device. When the heat medium circulates through the battery thermal circuit 120, the heat exchanger 140 receives heat from the high-temperature side heat medium, and the temperature of the battery 200 can be increased. The chiller 160 absorbs heat of the heat medium of the battery thermal circuit 120, and the battery 200 can be cooled. The temperature of the battery 200 can be adjusted by the heat medium circulating through the battery thermal circuit 120.

The LT thermal circuit 130 includes a channel through which a low-temperature side heat medium flows and circulates. The LT thermal circuit 130 includes the electric pump 131, an electricity supply unit (ESU) 132, a power control unit (PCU) 133, the MG 134, and a low-temperature radiator 135. The electric pump 131 circulates the low-temperature side heat medium through the LT thermal circuit 130. The low-temperature side heat medium may be a coolant such as a long life coolant (LLC). The low-temperature side heat medium exchanges heat with each device while passing through each device. When a request is made to cool the ESU 132, the PCU 133, and the MG 134, the electric pump 131 is operated to cool the ESU 132, the PCU 133, and the MG 134.

A refrigerant circulates through the refrigeration cycle 150. The refrigeration cycle 150 includes a compressor 151, a condenser 152, an electric expansion valve 153, an evaporator 154, an evaporative pressure regulator (EPR) 155, and an electric expansion valve 156. The compressor 151 compresses the refrigerant that flows out from the chiller 160 and discharges the refrigerant. The evaporator 154 is used as a cooling source of the air conditioner 2. The chiller 160 is connected to both the refrigeration cycle 150 and the battery thermal circuit 120, and serves as a heat exchanger. The chiller 160 exchanges heat between the refrigerant circulating through the refrigeration cycle 150 and the heat medium flowing through the battery thermal circuit 120. When a request is made to cool the battery 200, the heat medium of the battery thermal circuit 120 is cooled by the chiller 160, thereby cooling the battery 200.

The air conditioner 2 performs heating using heat released from the heater core 114, and performs cooling using the evaporator 154 as the cooling source. The high-temperature radiator 112, the low-temperature radiator 135, and the condenser 152 are provided at the front of the vehicle 1, and efficient heat exchange (cooling) is performed by wind generated while the vehicle 1 is traveling.

The electric pump 111, the electric pump 115, and the electric pump 121 are operated by electric power from an auxiliary battery (not shown). The electric pump 111 is an example of a "first electric pump" according to the present disclosure, and the electric pump 115 is an example of a "second electric pump" according to the present disclosure. The electric heater 116 is operated by electric power from the battery 200. The hybrid system of the vehicle 1 may be of any of a series type, a parallel type, or a series-parallel type. The MG 134 that is the drive motor for the vehicle 1 is driven by electric power from the battery 200. The battery 200 and the auxiliary battery may be connected via a DC-DC converter, and the electric power of the auxiliary battery may be supplemented with the electric power of the battery 200.

When the internal combustion engine 300 is operating and there is neither a request to perform heating by the air conditioner 2 nor a request to increase the temperature of the battery 200, the ports P1 and P2 of the four-way valve 400 are closed. Then, the electric pump 111 is operated, and the high-temperature side heat medium (LLC) flows through a cylinder block (coolant passage) of the internal combustion engine 300. The thermostat 113 is closed until the warm-up of the internal combustion engine 300 is completed, and the high-temperature side heat medium flows and circulates through the channel 110a, the channel 110c, and the bypass channel 110d. The thermostat 113 is opened when the warm-up of the internal combustion engine 300 is completed and the temperature of the high-temperature side heat medium reaches a predetermined temperature (e.g., 85°C). Then, the high-temperature side heat medium that has cooled the internal combustion engine 300 flows through the channel 110b and exchanges heat (releases heat) in the high-temperature radiator 112, thereby suppressing overheating of the internal combustion engine 300. The HT thermal circuit 110 including the channel 110a is an example of a "first thermal circuit" according to the present disclosure.

When the internal combustion engine 300 is operating and a request is made to perform heating by the air conditioner 2, the ports P2 and P4 of the four-way valve 400 are connected, and the high-temperature side heat medium circulated by the electric pump 111 flows through the channel 110f. Therefore, the heat of the high-temperature side heat medium heated by the internal combustion engine 300 is released from the heater core 114 to perform heating.

When a request is made to perform heating by the air conditioner 2 and the internal combustion engine 300 is stopped or the temperature of the high-temperature side heat medium flowing through the channel 110a is low, the ports P1 and P4 of the four-way valve 400 are connected. Then, the electric pump 115 is operated, and the electric heater 116 is energized. Therefore, the high-temperature side heat medium flowing through the channel 110e is heated by the electric heater 116, and flows through the channel 110f to perform heating by releasing heat from the heater core 114. The HT thermal circuit 110 including the channel 110e is an example of a "second thermal circuit" according to the present disclosure.

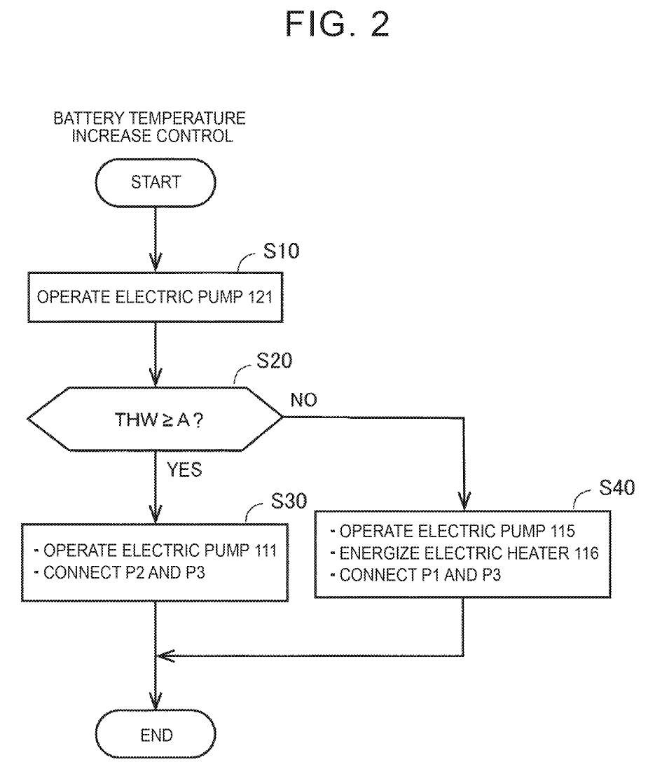

FIG. 2 is a flowchart showing an example of a battery temperature increase control process to be performed by the ECU 500. This process is repeated at predetermined time intervals when a request is made to increase the temperature of the battery 200. The request to increase the temperature of the battery 200 is generated when a battery temperature TB detected by a monitoring unit 13 (see FIG. 1) is equal to or lower than a set temperature. The set temperature may be, for example, 5°C, 0°C, or 10°C.

In step (step will be hereinafter abbreviated as "S") 10, the electric pump 121 is operated. When the electric pump 121 is operated, the heat medium circulates through the battery thermal circuit 120, and the heat exchanger 140 receives heat from the high-temperature side heat medium. Thus, the temperature of the battery 200 can be increased.

In S20, determination is made as to whether a temperature THW of the high-temperature side heat medium flowing through the channel 110a is equal to or higher than a predetermined temperature A. The temperature THW may be detected by a temperature sensor 12 provided at the outlet of the channel 110a of the internal combustion engine 300. The temperature THW corresponds to a coolant temperature of the internal combustion engine 300. The predetermined temperature A may be, for example, 50°C. The predetermined temperature A may be set in conjunction with the battery temperature TB, and may be set to a value higher than the battery temperature TB. When the temperature THW is equal to or higher than the predetermined temperature A, affirmative determination is made and the process proceeds to S30. When the temperature THW is lower than the predetermined temperature A, negative determination is made and the process proceeds to S40.

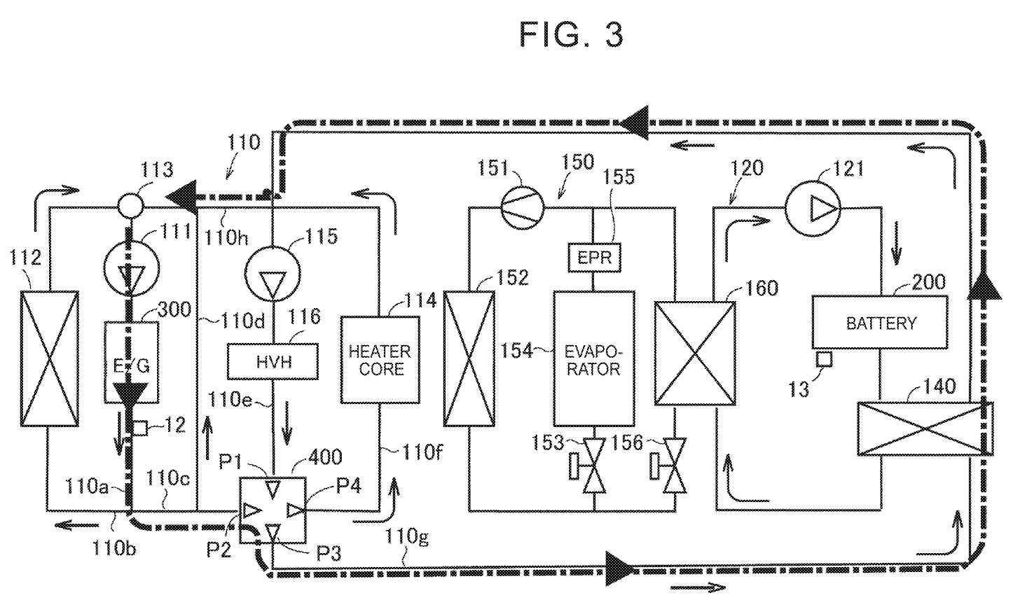

In S30, the electric pump 111 is operated, and the ports P2 and P3 of the four-way valve 400 are connected. When the electric pump 111 is operating, the electric pump 111 continues to operate. FIG. 3 illustrates an increase in temperature of the battery 200 using waste heat from the internal combustion engine 300. When the electric pump 111 is operated and the ports P2 and P3 of the four-way valve 400 are connected, the high-temperature side heat medium circulates through the HT thermal circuit including the channel 110a and the channel 110g as indicated by the long dashed short dashed lines in FIG. 3. The heat medium of the battery thermal circuit 120 receives, in the heat exchanger 140, heat from the high-temperature side heat medium heated by the internal combustion engine 300, and the temperature of the battery 200 is increased. Thus, it is possible to increase the temperature of the battery 200 using the waste heat from the internal combustion engine 300.

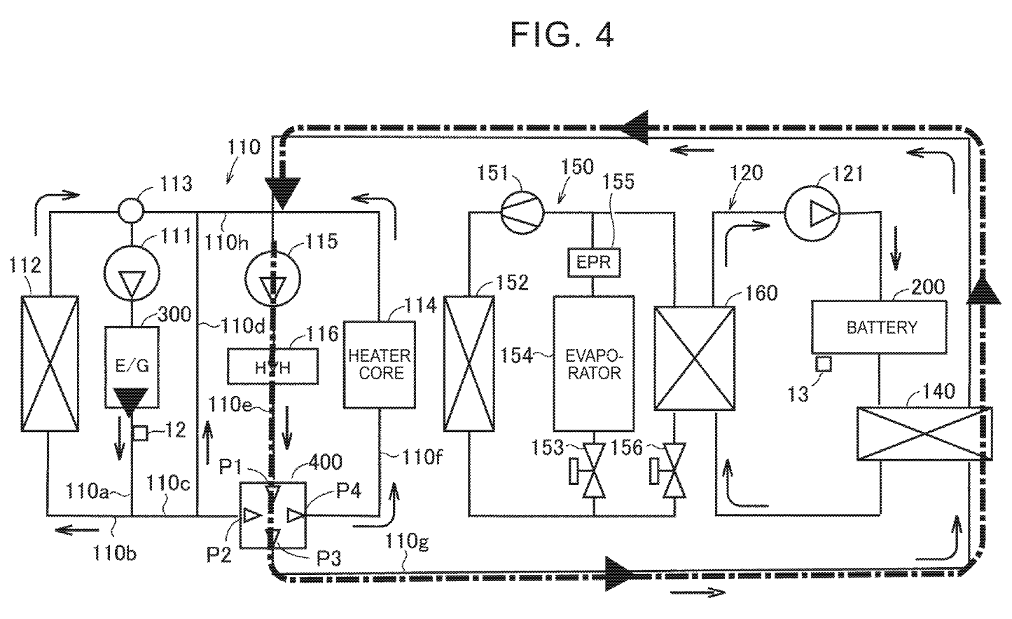

In S40, the electric pump 115 is operated, and the electric heater 116 is energized. Then, the ports P1 and P3 of the four-way valve 400 are connected. FIG. 4 illustrates an increase in temperature of the battery 200 using the electric heater 116. When the electric pump 115 is operated, the electric heater 116 is energized, and the ports P1 and P3 of the four-way valve 400 are connected, the high-temperature side heat medium circulates through the HT thermal circuit including the channel 110e and the channel 110g as indicated by the long dashed short dashed lines in FIG. 4. The heat medium of the battery thermal circuit 120 receives, in the heat exchanger 140, heat from the high-temperature side heat medium heated by the electric heater 116, and the temperature of the battery 200 is increased. Thus, it is possible to increase the temperature of the battery 200 using the electric heater 116.

The battery temperature increase control in FIG. 2 continues when the battery temperature TB is equal to or lower than the set temperature and a request is made to increase the temperature of the battery 200, and ends when the battery temperature TB exceeds the set temperature and the request to increase the temperature is terminated.

In the present embodiment, when a request is made to increase the temperature of the battery 200 and the temperature THW of the high-temperature side heat medium of the HT thermal circuit 110 that includes the channel 110a and cools the internal combustion engine 300 is equal to or higher than the predetermined temperature A, the electric pump 111 is driven, and heat is exchanged between the high-temperature side heat medium of the channel 110a and the heat medium of the battery thermal circuit 120. When the temperature THW is lower than the predetermined temperature A, the electric pump 115 is driven, the electric heater 116 is energized, and heat is exchanged between the high-temperature side heat medium of the channel 110e and the heat medium of the battery thermal circuit 120. Therefore, even while the internal combustion engine 300 is stopped, the temperature of the battery 200 can be increased using the waste heat from the internal combustion engine 300. When the waste heat from the internal combustion engine 300 cannot be used, the temperature of the battery 200 can be increased using the electric heater 116. Thus, it is possible to increase the temperature of the battery 200 while reducing the power consumption of the electric heater 116. The electric heater 116 is energized using electric power of the battery 200 that is the power source for the MG 134. Since the power consumption of the electric heater 116 is reduced, a decrease in the cruising distance of the vehicle 1 due to an increase in temperature of the battery 200 can be suppressed.

In the present embodiment, the high-temperature side heat medium flowing through the channel 110a and the channel 110e is used for heating the air conditioner 2. The electric heater 116 to be used for heating can also be used for increasing the temperature of the battery 200.

When requests are made to perform heating by the air conditioner 2 and to increase the temperature of the battery 200 and the temperature THW is low, the ports P1, P3, and P4 of the four-way valve 400 may be connected, the electric pump 115 may be operated, and the electric heater 116 may be energized. When the temperature THW is high or the internal combustion engine 300 is operating, the electric pump 111 may be operated (or the operation may be continued) and the ports P2, P3, and P4 of the four-way valve 400 may be connected.

The embodiment disclosed herein should be construed as illustrative in all respects and not restrictive. The scope of the present disclosure is shown by the claims rather than by the above description of the embodiment and is intended to include all modifications within the meaning and scope equivalent to the claims.

What is claimed is:

1. A thermal management device for a vehicle including an internal combustion engine, a motor, and a battery that is a power source for the motor, the thermal management device comprising:
a battery thermal circuit through which a heat medium circulates to adjust a temperature of the battery;
a first thermal circuit configured to cool the internal combustion engine using a heat medium circulated by a first electric pump;
a second thermal circuit in which a temperature of a heat medium circulated by a second electric pump is increased by an electric heater; and
a heat exchanger configured to exchange heat between each of the heat medium flowing through the first thermal circuit and the heat medium flowing through the second thermal circuit and the heat medium circulating through the battery thermal circuit, wherein, when a request is made to increase the temperature of the battery,
in a case where a temperature of the heat medium of the first thermal circuit is equal to or higher than a predetermined temperature, the first electric pump is driven, and heat is exchanged between the heat medium of the first thermal circuit and the heat medium of the battery thermal circuit, and
in a case where the temperature of the heat medium of the first thermal circuit is lower than the predetermined temperature, the second electric pump is driven, the electric heater is energized, and heat is exchanged between the heat medium of the second thermal circuit and the heat medium of the battery thermal circuit.

2. The thermal management device according to claim 1, wherein the electric heater is energized using electric power of the battery.

3. The thermal management device according to claim 1, further comprising an air conditioner configured to perform heating in a vehicle cabin, wherein the heat medium flowing through the first thermal circuit and the heat medium flowing through the second thermal circuit are used for the heating.
